(19) United States
(12) Patent Application Publication
(10) Pub. No.: US 2005/0237310 A1
(43) Pub. Date: Oct. 27, 2005

(54) User interface

(75) Inventors: Henna Fabritius, Tampere (FI); Tiina Hynninen, Oulu (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/967,024

(22) Filed: Oct. 15, 2004

(30) Foreign Application Priority Data
Apr. 23, 2004 (FI) 20045149

(51) Int. Cl. G09G 5/00

(52) U.S. Cl. 345/173

(57) ABSTRACT

A device comprising a touch screen (2) which reacts to a touch by a touching means (3, 7) or a corresponding input and which is arranged to display one or more user interface elements (8), and status means (5) for detecting the active mode of the touching means (3, 7) giving the input to the touch screen (2). The device is arranged to adapt one or more user interface elements (8) displayed on the touch screen (2) to be suitable for the touching means (3, 7) whose active mode is detected by the mode status means (5). The invention also relates to a device, a computer program product and a software product implementing the method.

### CROSS-REFERENCE TO RELATED APPLICATIONS

This application claims priority under 35 USC §119 to Finnish Patent Application No. 20045149 filed on Apr. 4, 2004.

### FIELD OF THE INVENTION

The invention relates to a device having a touch screen and status detection of the device in cooperative engagement with the input associated with the touch screen. The invention also relates to a corresponding user interface and a corresponding system. It also relates to a touch screen module and a method for adapting a user interface to be suitable for two or more different touching states. It also relates to a computer program product and a software product for controlling the functions of a device having a touch screen and status indication thereof.

### BACKGROUND OF THE INVENTION

In various electronic devices, it is known to use a touch panel or a corresponding device to detect a touch or another effect as well as to determine the touching point or effective point. This type of a touch panel is typically used placed on top of a display terminal, in which case this type of an arrangement is also referred to as a touch screen. The user of the electronic device can thus perform selection operations and the like by touching the surface of the touch panel at an appropriate point. The information shown on the display can thus be used in selecting the touch point. For example, selection areas are formed on the display, information connected to the selection areas being displayed in connection with them. This information can be, for example, a text that discloses which function is activated in the electronic device by touching the selection area in question. The information can also be image information, such as a symbol, which discloses a function.

For touching a touch screen, it is possible to use, for example, a finger or a particular touching tool, such as a marking tool or a stylus. In many portable electronic devices, the touch screen is relatively small in size, for which reason a separate touching tool is primarily used in such applications. The use of a touching tool makes it possible to select the desired selection data from the information displayed in small size.

One problem in known arrangements is that the user cannot make the selection (i.e. touch) on the touch screen accurately without a touching tool, for example with a finger only. However, the use of another means than the touching tool would be preferable in many use situations. Such a situation is, for example, the answering of a call.

### SUMMARY OF THE INVENTION

Now, a solution is presented for controlling the touch screen to be touched, for example, with a touching tool, with a finger, or in another way, which makes the use of the touch screen easier for the user.

The basic idea of the invention is to detect, whether a touching tool is used for touching the touch screen or not, and to change the information to be displayed on the touch screen and the user interface elements to be suitable for the touching means used.

Various touching means have different properties including, for example, the surface area touching the screen and the touch surface. To utilize these properties, it is advantageous to tune, i.e., to calibrate the control settings for the different touching means to be as individual as possible; these settings can be used, for example, to adapt the user interface. In one embodiment of the invention, it is possible to calibrate the user interface to be suitable for the touching means to be used. In one embodiment, the detection of the touching means and the determination of the control settings are performed during the step of calibration of the touch screen, wherein the user touches the touching points determined by the device with a touching means. On the basis of the touches, the device sets up information about the surface area and the touch surface of the touching means. The touching points can be freely located on the touch screen, for example in the corners and in the centre of the screen. The calibration of the touching means and the screen can be performed at different steps of usage, for example when the device is taken in use. In one embodiment, the calibration can be performed at any time when the user so wishes. In one embodiment, the sizes of the user interface elements are changed to correspond to the properties of the touching means in connection with the calibration.

In one embodiment, it is detected when a particular touching tool, such as, for example, a marking tool, is in use, i.e., in the active mode, and when it is not in use, i.e. when the touching tool is, for example, in a passive or standby mode. On the basis of the mode data, the information to be displayed on the touch screen and the user interface elements are. controlled to be suitable for the touching tool used.

One embodiment of the device according to the invention comprises a touch screen which reacts to the touch or a corresponding input of the touching means and on which user interface elements are displayed, as well as status means for detecting the mode of the touching means giving the input to the touch screen. The device is arranged to adapt one or more user interface elements to be displayed on the touch screen to be suitable for the touching means detected by the mode status means.

The detection of the touching means used can be implemented in a number of ways. One way is to detect when the touching tool is in the active mode, wherein the touching tool is defined as the touching means. The mode detection can be implemented in a variety of ways, for example by a mechanical, optical or electromagnetic sensor.

In one embodiment, in turn, the touching means is identified on the basis of the touch sensed by the touch screen. It is thus possible, for example, to display the information and the user interface elements adapted to such a touching means which was last used for touching the screen. The detection of the touching means can be implemented in a number of ways, depending primarily on the principle of operation of the touch screen.

It is also possible to form the information on the type of the touching means by a separate control structure controlled by the user. However, for the user, it is often more practical if the data of the touching means is produced without the need for a control by the user.

According to the invention, the settings of the touch screen are changed according to the touching means in use. The aim is to optimize the displayed information to be suitable for the touching means. In one embodiment of the invention, the size of the displayed information and of user interface elements is changed depending on whether a touching tool is used or not. It is often possible to use a touching tool to touch and/or to select smaller details than, for example, with a finger, wherein it is possible to display small user interface elements when a touching tool is used and large user interface elements when a finger is used as the touching means.

In one embodiment of the invention, different user interface elements can also be prioritized; that is, they can, for example, be arranged in an order of priority, by which some elements can be left out in the case of larger user interface elements. It is thus possible to magnify the user interface elements to be displayed according to the touching means of the user.

In another embodiment, in turn, the data of the touching means is used to affect the type of applications displayed. For example, when the touching means is a pen-like touching tool, e.g. such applications are displayed in which it is possible, for example, to write or draw with said touching tool. On the other hand, when another touching means is used than the touching tool, for example a finger, it is possible to display finger-controllable applications, such as various lists.

By the arrangement according to the invention, many advantages are achieved when compared with the solutions of prior art. One embodiment of the invention makes it possible to use various touching means in an efficient way. Another embodiment, in turn, makes it possible to adapt the quantity and/or quality of the information displayed, for example to optimize the displayed information to be more suitable for the performance of the touching means.

One embodiment of the invention also improves the usability, because the size of the user interface elements corresponds better to the touching means used, wherein the occurrence of error touches and thus error selections is reduced. In another embodiment, calibration of the device is used to secure the manipulation of the user interface at a sufficient accuracy, wherein the probability of error touches, which reduce the usability, is decreased. Furthermore, the calibration can also be used to secure the matching of the coordinates of the pixels used for drawing an image visible to the user and those of the film detecting the touch.

One embodiment of the invention makes it possible to display a large quantity of information, such as several small icons. The displaying of several small icons is, in many cases, user friendly when a touching tool is used.

The present invention is thus directed to such devices and methods as well as corresponding user interfaces, systems, touch screen modules, computer program products and software products.

The solution presented by the invention can be used in a variety of devices with a touch screen. In many applications, only a part of the functions of the device are controlled with the help of the touch screen, but it is also possible to implement a device in which all the functions are controlled via the touch screen. Possible devices in which the arrangement of the invention is advantageous, include mobile stations, communication devices, electronic notebooks, personal digital assistants (PDA), various combinations of the above devices, as well as other devices in which touch screens are used. The invention is also suitable for use in systems which comprise a device module with a touch screen. Thus, the device module with the touch screen can be used to control functions of the system via the touch screen. The different functions of the system can be implemented in different device elements, depending on the assembly and use of the system.

### DESCRIPTION OF THE DRAWINGS

In the following, the invention will be described in more detail with reference to the appended principle drawings, in which

FIG. 1 shows a device equipped with a touch screen,

FIG. 2 shows a view of a touch screen according to one embodiment, in a form optimized for a finger,

FIG. 3 shows a view of a touch screen in a form optimized for a touching tool,

FIG. 4 shows another device equipped with a touch screen, and

FIG. 5 illustrates the basic idea of an embodiment of the invention in a block chart.

For the sake of clarity, the figures only show the details necessary for understanding the invention. The structures and details which are not necessary for understanding the invention and which are obvious for anyone skilled in the art have been omitted from the figures in order to emphasize the characteristics of the invention.

### DETAILED DESCRIPTION OF THE INVENTION

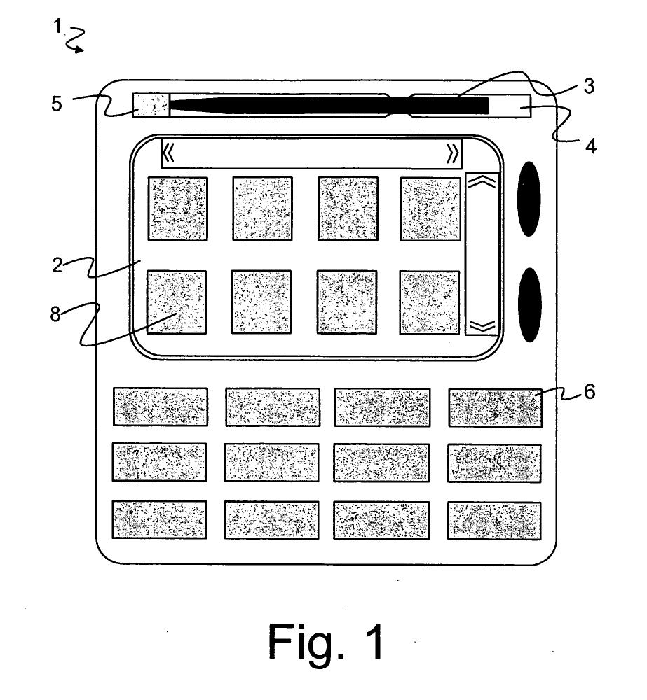

FIG. 1 shows, in a principle view, an electronic device 1 which comprises at least a touch screen 2 and a touching tool 3 as well as a holder 4 for the touching tool. In the presented example, the means for detecting the status (mode) of the touching tool 3 is a presence detector 5, such as, for example, a switch or a sensor, which is used to generate information when the touching tool 3 is in its position in the holder 4. Furthermore, the electronic device 1 may comprise other necessary structures, such as, for example, buttons 6. Mobile communication applications are naturally equipped with the means required for communication.

In this context, it should be mentioned that in this description a touch does not solely refer to a situation, in which the touching means (touching tool 3 and user's finger 7) touches the surface of the touch screen 2, but the touch can in some cases be also sensed in a situation, in which the touching means 3,7 is sufficiently close to the surface of the touch screen 2 but does not touch it. Furthermore, the surface of the touch screen 2 can be provided with e.g. a protective film, in which case this protective film can be touched, or the touching means 3, 7 is sufficiently close to it and the touch screen 2 can sense the touch. This type of a touch screen 2, not requiring a physical touch, is normally carried out by the capacitive and/or optical principle.

The touch screen 2 is typically equipped with a touch screen controller, in which the necessary steps are taken to control the operation of the touch screen and to detect touches (or said corresponding inputs). In one embodiment, the controller of the touch screen 2 forms the coordinates of the touch point and transmits them e.g. to the control block of the electronic device 1. On the other hand, the steps required for controlling the operation of the touch screen 2 and for sensing a touch can, in some applications, be also performed in the control block of the electronic device 1, in which case a separate controller for the touch screen is not required.

In implementing the touch screen 2, it is possible to use a variety of techniques, non-limiting examples of which include touch screens based on optical detection, capacitive touch screens and resistive touch screens. In view of the present invention, the type of the touch screen 2 is not significant, nor is the principle how the different touch points are sensed.

In FIG. 1, the touching tool 3 is in the holder 4, i.e., in the passive mode. The holder 4 may be arranged in a variety of ways, for example in the form of a groove-like recess for receiving the touching tool 3, as 'shown in the figure. One commonly used way of implementing the holder 4 in portable electronic devices is to arrange the holder as a tunnel-like structure in which the touching tool 3 is inserted when it is not needed. In the embodiment of FIG. 1, when the touching tool 3 is in the passive mode, the information is displayed on the touch screen 2 of the device 1 in such a form that it can be easily manipulated with a finger. In practice, this means that the user interface elements 8 are displayed in a size suitable for a finger on the touch screen 2. In the figures, the user interface elements 8 are illustrated as simple boxes, but they may vary in a number of different shapes and they may also comprise various information, such as text, images and/or symbols. The user interface elements 8 may also form a matrix, as in the example, but also another array is possible, such as, for example, a list or an array in a free format. It is also possible that the user interface element 8 comprises a zone around the information, wherein a touch in this zone is interpreted to relate to the motif in question. Between adjacent user interface elements 8, there may be a neutral zone which can be touched without relating to any motif and thus without activating any function. It is also possible to arrange the adjacent user interface elements 8 without the above-mentioned neutral zone.

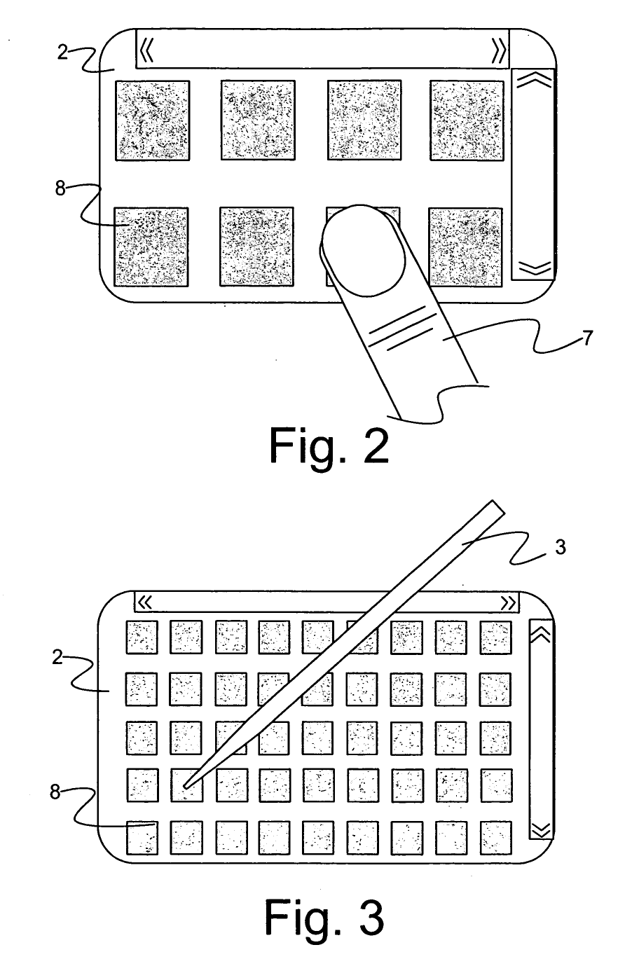

FIG. 2 illustrates user interface elements 8 displayed on the touch screen 2 and dimensioned for a finger. Furthermore, the figure shows a finger 7 which is used as the touching means in this embodiment. The figure shows that the tip of the finger 7 easily forms a large touching area on the surface of the touch screen 2 when it touches the touch screen. When the user interface elements 8 are enlarged, it is easy for the user to point at the desired user interface element with the finger.

In one embodiment, the centre of gravity of the touching area of the finger 7 is determined, and this information is used to determine the user interface element 8 which is primarily activated by the touching area of the finger. For determining the centre of gravity of the touching area, various ratios can be defined for different points of the user interface element 8. Thus, a touch on the point of identification data of the user interface element 8 can be allocated, for example, a high weight value, wherein such a touch is interpreted to be related to said identification data and the respective function, irrespective of other touches detected by the touch screen 2.

In another embodiment, in turn, the user interface is calibrated to be suitable for the touching means 3, 7 to be used. One possible way of identifying the touching means 3, 7 and determining various parameters for the control setting data is the step of calibration. Thus, the user for example goes through the touching points determined by the device 1. On the basis of the touches by the touching means 3, 7, the device 1 sets up information about the surface area and the touch surface of the touching means. The touching points can be freely located on the screen, for example in each corners and in the centre of the screen. By determining individual parameters for the touching means 3, 7, the user interface can be manipulated at a sufficient accuracy. This, in turn, reduces or eliminates the number of error touches which reduce the usability. By calibration, it is also possible to secure the matching of the pixels to be used for drawing an image visible to the user and the coordinates on the film detecting the touching and to correct the control values, if necessary.

Furthermore, one could add a mention somewhere that the device may be used by several users and it could therefore display different icons or icons with different sizes. For example, a person with thin fingers does not need as large icons as a person with thick fingers.

The above-presented calibration of the user interface and the creation of control setting data according to the touching means 3, 7 are carried out in different steps of usage, for example when the device is taken in use. Typically, the calibration is carried out when introducing such a touching means 3, 7, whose properties differ from the properties of the touching means 3, 7 previously in use. In one embodiment, the calibration and the creation of control setting data can be performed at any time when the user so wishes. In one embodiment, in connection with the calibration, the values effective on the sizes of the user interface elements 8 are changed to comply better to the properties of the touching means 3, 7.

In FIG. 3, the touching tool 3 has been removed from the holder 4 (i.e., the touching tool is in the active mode), wherein, in one embodiment of the invention, the controller of the touch screen 2 has also been informed of this function. Thus, in the presented embodiment, the user interface elements 8 are provided on the touch screen 2 in a format optimized for said touching tool 3 in the active mode. In the example, the touching tool 3 is a pen-like pointer with a sharp tip, wherein it can be used to make also sharp outlines and touches. Thus, the user interface elements 8 can also be formed to have a small surface area, as shown in FIG. 3.

When the touching tool 3 is set in the active mode, for example by removing the touching tool 3 from the holder 4, the user interface elements 8 are changed from the form optimized for the finger 7 to the form optimized for the touching tool 3, i.e., for example, from the form shown in FIG. 2 to the form shown in FIG. 3. In a corresponding manner, for setting the passive mode, for example by placing the touching tool 3 in the holder 4, the user interface elements 8 are changed from the form optimized for the touching tool 3 to the form optimized for the finger 7. In the above-presented embodiment, the data on the active and passive modes of the touching tool 3 was based on whether the tool was in the holder 4 of the device or not. The mode data can also be produced in different ways which will be described in more detail below. Thus, in one embodiment, the touching tool may be detached from the main device comprising the touch screen, and still be in the passive or active mode. Naturally, the mode will thus primarily depend on data from a means 5 for detecting the mode of the touching tool 3.

The active and/or passive mode of the touching tool 3 can be detected in a number of different ways. In one embodiment, the presence of the touching tool 3 in the holder 4 is detected by a mechanical switch structure 5, wherein the status of said switch is changed depending on whether the touching tool is placed in or detached from the holder. In another embodiment, the presence of the touching tool 3 in the holder 4 is detected by an optical switch structure 5, and in a third embodiment, an electromagnetic switch structure is used to detect a change in the electromagnetic field caused by the touching tool 3. In one embodiment, the data about the position of the touching tool 3 is transmitted from the presence sensor 5 to the controller of the touch screen. The controller of the touch screen, in turn, arranges the information and the user interface elements 8 on the touch screen 2 in a form depending on the position of the touching tool (or, more generally, the mode of the touching tool).

The means 5 for detecting the mode of the touching tool 3, such as a switch or a sensor, can be placed in several different locations in the device 1, for example in the touching tool 3, in the holder 4, and/or in the touch screen 2. Depending on the location of placement and the requirements set by it, it is advantageous to select the most suitable status means 5. For example, in the touch screen, it is often advantageous to use an optical or electromagnetic sensor 5, and in the touching tool 3 and in the holder 4, it is often advantageous to use a mechanical or electromagnetic sensor. Also other types of means and sensors 5 can be used according to the present invention.

In one embodiment, the detection of the mode of the touching tool 3 is implemented with a switch structure in the touching tool 3. The switch structure may be controlled by the user consciously or unknowingly. Such an embodiment makes it possible, for example, that a detached touching tool which is not intended to be used for controlling (i.e., which is not on) will not cause the adaptation of the display.

The above-presented active mode and passive mode are only examples of various modes which the touching tools 3 and the finger 7 may have. In addition, some embodiments include other modes, such as, for example, various standby modes and precision modes. By selecting the precision mode, for example, it is possible to affect the touching accuracy of the touching tool 3.

FIG. 5 shows, in a block chart, the basic idea in one embodiment of the method according to the invention. The first step therein is to determine the mode of the touching tool. If the touching tool 3 is in the passive mode, the settings adapted for the finger 7 are used. If the touching tool 3 is in the active mode, in turn, the settings adapted for the touching tool are used.

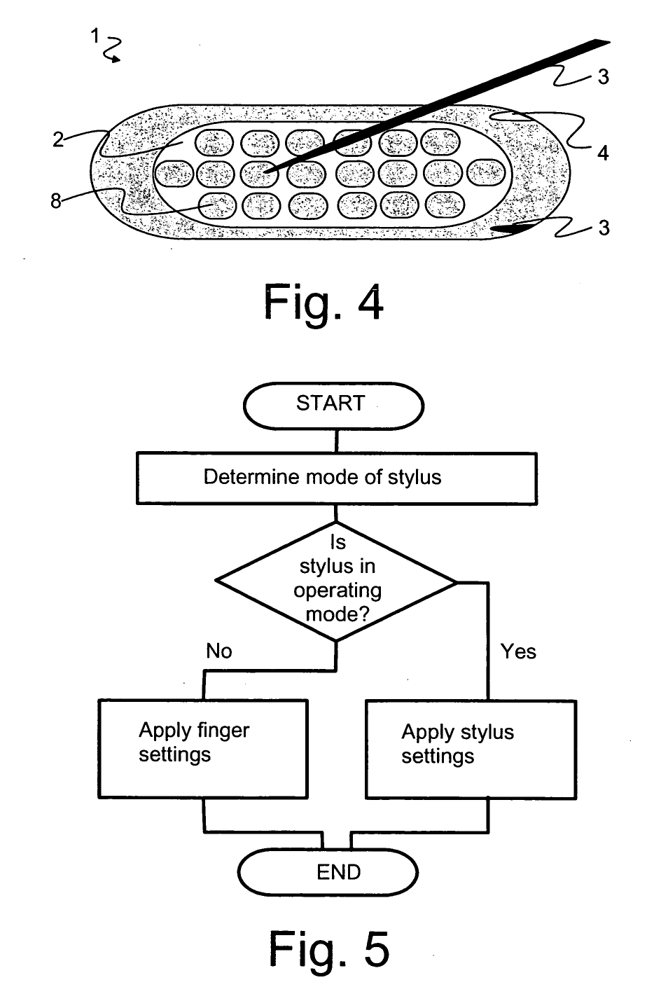

In the above description of some exemplary embodiments of the invention, the device 1 comprising only one touching tool 3 was used as an example. However, in one embodiment of the invention, shown in FIG. 4, there are several touching tools 3, each provided with a separate holder 4. In this case, the user interface elements 8 are formed on the display screen according to the touching tool in use. It is thus possible to form different views on the display screen 2 which are used, for example, with different touching tools 3, and which may have, for example, different applications available. In one embodiment, the touching tool 3 used is detected by the above-described structure suitable for detecting the mode of the touching tool 3. In the example, when all the separate touching tools 3 are placed in their respective holders 4 (i.e., the touching tools are not in the active mode), the touch screen 2 displays, according to one embodiment, the user interface elements 8 and information optimized for the finger 7. Naturally, there may be more touching tools 3 than the two shown in FIG. 4. The touching tools 3 can be either identical or different from each other, depending on the application. It is also possible that some of the touching tools 3 and holders 4 are not coupled in the above-presented way to the system of adapting the touch screen 2. These touching tools 3 can thus be used, for example, as replacement tools when the primary touching tool has been lost or damaged. In one embodiment, a touching tool 3 not coupled to the adapting system is used for touching the touch screen 2 when the touch screen is optimized for a finger 7 but the user still wants to manipulate it with the touching tool. Thus, according to one embodiment, a finger mode is defined for the touching tool 3, wherein the tool is interpreted as a finger 7 in connection with controlling the touch screen.

In one embodiment of the invention, there is also a function by which the user can select the desired optimization for the touch screen 2, irrespective of the touching means 3, 7 used. Thus, for example when the touching tool 3 is lost or damaged, the user can select the user interface optimized for the finger 7, even though the data from the presence sensor 5 indicates that the user interface optimized for the touching tool should be used. Thus, in one embodiment, a “not-in-use” mode is defined for the touching tool 3, wherein the data on said tool does, not affect the control of the touch screen.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

1. A device comprising
a touch screen which reacts to a touch by a touching means or a corresponding input and which is arranged to display one or more user interface elements, and
status means for detecting the active mode of the touching means giving an input to the touch screen,
wherein the device is arranged to adapt one or more user interface elements displayed on the touch screen to be suitable for the touching means whose active mode is detected by the status means.

2. The device according to claim 1, wherein it is also arranged to adapt the user interface elements displayed on the touch screen to a form suitable for a finger used as the touching means when no touching tool in the active mode is detected by the status means.

3. The device according to claim 1, wherein it is also arranged to detect the surface area of the structure of the touching means in the active mode, giving an input to the touch screen, and to use it to generate adapting data.

4. The device according to claim 1, wherein the device also comprises a holder for placement of the touching tool when it is not used as the touching means.

5. The device according to claim 1, wherein the status means is arranged in one of the following:
in connection with the touch screen,
in the touching tool,
in the holder.

6. The device according to claim 1, wherein the status means is a sensor with a mechanical, optical or electromagnetic principle of operation.

7. The device according to claim 1, wherein the electronic device is one of the following: a mobile station, a communication device, an electronic notebook, a personal digital assistant.

8. A user interface comprising
a touch screen which reacts to a touch by a touching means or a corresponding input and which is arranged to display one or more user interface elements, and
status means for detecting the active mode of the touching means giving an input to the touch screen,
wherein the user interface is arranged to adapt one or more user interface elements to be displayed on the touch screen to be suitable for the touching means whose active mode is detected by the status means.

9. The user interface according to claim 8, wherein it is also arranged to adapt the user interface elements displayed on the touch screen to a form suitable for a finger used as the touching means, when no touching tool in the active mode is detected by the status means.

10. The user interface according to claim 8, wherein it is also arranged to detect the surface area of the structure of the touching means in the active mode, giving an input to the touch screen, and to use it to generate adapting data.

11. The user interface according to claim 8, wherein it also comprises a holder for the placement of the touching tool when it is not used as the touching means.

12. The user interface according to claim 8, wherein the status means is arranged in one of the following:
in connection with the touch screen,
in the touching tool,
in the holder.

13. The user interface according to claim 8, wherein the status means is a sensor with a mechanical, optical or electromagnetic principle of operation.

14. A system comprising one or more touching tools as well as a user interface which, in turn, comprises
a touch screen which reacts to a touch by a touching means or a corresponding input and which is arranged to display one or more user interface elements, and
status means for detecting the active mode of the touching means giving an input to the touch screen,
wherein some part of the system is arranged to adapt one or more user interface elements displayed on the touch screen to be suitable for the touching means whose active mode is detected by the status means.

15. The system according to claim 14, wherein it is also arranged to adapt the user interface elements displayed on the touch screen toga form suitable for a finger used as the touching means when no touching tool in the active mode is detected by the status means.

16. The system according to claim 14, wherein it is also arranged to detect the surface area of the structure of the touching means in the active mode, giving an input to the touch screen, and to use it to generate adapting data.

17. The system according to claim 14, wherein the device also comprises a holder for the placement of the touching tool when it is not used as the touching means.

18. The system according to claim 14, wherein the status means is arranged in one of the following:
in connection with the touch screen,
in the touching tool,
in the holder.

19. The system according to claim 14, wherein the status means is a sensor with a mechanical, optical or electromagnetic principle of operation.

20. A touch screen module comprising
a touch screen which reacts to a touch by a touching means or a corresponding input and which is arranged to display one or more user interface elements, and
status means for detecting the active mode of the touching means giving an input to the touch screen,
wherein some part of the module is arranged to adapt one or more user interface elements displayed on the touch screen to be suitable for the touching means whose active mode is detected by the mode status means.

21. The touch screen module according to claim 20, wherein it is also arranged to adapt the user interface elements displayed on the touch screen to a form suitable for a finger used as the touching means when no touching tool in the active mode is detected by the status means.

22. The touch screen module according to claim 20, wherein it is also arranged to detect the surface area of the structure of the touching means in the active mode, giving an input to the touch screen, and to use it to generate adapting data.

23. The touch screen module according to claim 20, wherein the device also comprises a holder for the placement of the touching tool when it is not used as the touching means.

24. The touch screen module according to claim 20, wherein the status means is arranged in one of the following:
in connection with the touch screen,
in the touching tool,
in the holder.

25. The touch screen module according to claim 20, wherein the status means is a sensor with a mechanical, optical or electromagnetic principle of operation.

26. A method for adapting a user interface to be suitable for two or more different touching means, wherein user interface elements are displayed on the touch screen of a user interface reacting to a touch by the touching means or a corresponding input, the user interface elements being manipulated by the touching means, such as a touching tool, in an active mode to form control commands, wherein the user interface elements displayed on the touch screen are arranged in a form suitable for the touching tool in the active mode.

27. The method according to claim 26, wherein the user interface elements displayed on the touch screen are arranged in a form suitable for a finger used as the touching means when the touching tool is not in the active mode.

28. The system according to claim 26, wherein the surface area of the structure of the touching means in the active mode, giving an input to the touch screen, is detected and used to generate adapting data.

29. The method according to claim 26, wherein the active mode of the touching means giving an input to the touch screen is detected by status means.

30. The method according to claim 26, wherein the user interface elements displayed on the touch screen have a larger surface area when the touching tool is not in the active mode, and the user interface elements displayed on the touch screen have a smaller surface area when the touching tool is in the active mode.

31. The method according to claim 26, wherein the user interface also comprises a holder in which the touching tool is placed when it is not used as the touching means.

32. The method according to claim 26, wherein the mode of the touching tool is detected by a status means which is arranged in one of the following:
in connection with the touch screen,
in the touching tool,
in the holder.

33. The method according to claim 26, wherein the mode of the touching tool is detected by the status means which is a sensor with a mechanical, optical or electromagnetic principle of operation.

34. A computer program product for controlling the functions of a device, which device comprises
a touch screen which reacts to a touch by a touching means or a corresponding input, for displaying user interface elements,
status means for detecting the active mode of the touching means giving an input to the touch screen,
the computer program product further comprising program commands for execution on or processor for forming control settings of the touch screen which are suitable for the touching tool used as the touching means, wherein the computer program product further comprises program commands for
determining if the touching tool is in the active mode and for forming the sensor data describing the status,
arranging, for the touch screen, the user interface elements corresponding to the control settings suitable for the touching tool, when the sensor data indicates that said touching tool is in the active mode.

35. The computer program product according to claim 34, wherein the computer program product also comprises program commands for
forming the control settings of the touch screen which are suitable for a finger used as the touching means, and
arranging, for the touch screen, the user interface elements corresponding to the control settings suitable for the finger, when the sensor data indicates that said touching tool is in a mode other than the active mode.

36. The computer program product according to claim 34, wherein the computer program product also comprises program commands for
forming user interface elements with a large surface area when the touching tool is in a mode other than the active mode, and
forming user interface elements with a smaller surface area when the touching tool is in the active mode.

37. The computer program product according to claim 34, wherein the device also comprises a holder for the placement of the touching tool when it is not used as the touching means, and the computer program product comprises program commands to determine if the touching-tool is placed in the holder.

38. A software product for storing a computer program, which product comprises a computer program for controlling the functions of a device, which device comprises
a touch screen which reacts to a touch by a touching means or a corresponding input, for displaying user interface elements,
status means for detecting the active mode of the touching means giving an input to the touch screen,
the software product comprising program commands for forming control settings of the touch screen which are suitable for the touching tool used as the touching means, wherein the software product comprises program commands for
determining if the touching tool is in the active mode and for forming the sensor data describing the status,
arranging, for the touch screen, the user interface elements corresponding to the control settings suitable for the touching tool, when the sensor data indicates that said touching tool is in the active mode.

39. The software product according to claim 38, wherein the software product also comprises program commands for
forming the control settings of the touch screen which are suitable for a finger used as the touching means, and
arranging, for the touch screen, the user interface elements corresponding to the control settings suitable for the finger, when the sensor data indicates that said touching tool is in a mode other than the active mode.

40. The software product according to claim 38, wherein the software product also comprises program commands for
forming user interface elements with a large surface area when the touching tool is in a mode other than the active mode, and
forming user interface elements with a smaller surface area when the touching tool is in the active mode.

41. The software product according to claim 38, wherein the device also comprises a holder for the placement of the touching tool when it is not used as the touching means, and the software product comprises program commands to determine if the touching tool is placed in the holder.
